(19) United States
(12) Patent Application Publication
(10) Pub. No.: US 2013/0199662 A1
(43) Pub. Date: Aug. 8, 2013

(54) REFILLABLE LIQUID PRODUCT CONTAINER

(71) Applicants: Jeroen Gerrit Anton Gebbink, Bruxelles (BE); Marco Koekkoek, Delft (NL)

(72) Inventors: Jeroen Gerrit Anton Gebbink, Bruxelles (BE); Marco Koekkoek, Delft (NL)

(73) Assignee: IPN IP B.V., Houten (NL)

(21) Appl. No.: 13/577,894

(22) PCT Filed: Feb. 4, 2011
(86) PCT No.: PCT/NL2011/050082

§ 371 Date: Oct. 23, 2012

(30) Foreign Application Priority Data
Feb. 8, 2010 (NL) 2004210

(51) Int. Cl. B67D 7/36; B65D 47/00; B67D 7/42; B65D 51/18

(52) U.S. Cl. CPC B67D 7/36; B65D 51/18; B65D 47/00; B67D 7/42
USPC 141/2; 220/254.1; 141/349

(57) ABSTRACT

A refillable liquid product container system comprises a liquid product container (100) having a body and a neck extending outwardly from the body, wherein said neck or an optional dispensing fitment arranged in said neck facilitates dispensing of a liquid product from the container. The system also includes a manually operable screw cap (1) that is to be removed by a user from the container (100) when a liquid product is to be dispensed from the container, and that is to be replaced to close the container. The screw cap has a top wall (2) and a downward depending circumferential skirt (3), and wherein the screw cap has a screw thread (11) that mates with a screw thread on said neck or on said optional dispensing fitment when present. A refilling station (110) allowing a user to refill the container (100) with a liquid product, said refilling station comprising a male filling element (30) through which said liquid product is supplied to the container.

The present invention relates to a refillable liquid product container system.

Refillable liquid product container systems, in particular for household products, e.g. detergents and liquid laundry products, are known from the prior art.

In these known system the liquid product is packaged in unitary blow-molded hand-held plastic liquid product containers having a screw cap. This package is the most widely used form of package for such products.

In an alternative form the liquid product is packaged in a collapsible pouch, the pouch having a spout that forms the neck of the container.

Refilling such containers by consumers, in particular in a supermarket and/or by using a refilling station embodied as a vending machine, is for example proposed in EP 1 427 640 (Unilever), U.S. Pat. No. 6,578,763 (Restore Products), and US2004/0020723.

The refilling obviously has major beneficial effects for the environment, as a container may be used several times. For reason of food safety, refilling of liquid food products into a used container may not be acceptable or advisable. This problem seems not to apply to many non-food liquid products, e.g. detergents, laundry cleaning agents, fabric softeners, etc, but also like car related liquid products, e.g. engine oil, window washer liquid, etc.

In spite of the environmental benefits, the refilling of such containers, has not gained wide acceptance. Especially for the consumer market, wherein refilling is projected to be done by the consumer himself at a refilling station placed in a store, e.g. in a supermarket, a gas-station, etc., the existing systems seem not satisfactory.

It is an object of the present invention to provide an improved system that avoids drawbacks associated with known systems and will allow for easy refilling by consumers.

The present invention proposes a system according to the preamble of claim 1, which is characterized in that

the screw cap is provided with a tubular portion, preferably said tubular portion downwardly extending from the top wall, said tubular portion forming a bore for the male filling element of the refilling station, said bore having an insertion opening at the top wall for the male filling element,
and in that said tubular portion forms in said bore a seat for a stopper at a distance from the insertion opening,
and in that the container further comprises a stopper that is arranged in the seat to close off the bore,
and in that the male filling element has a tubular portion which fits into the bore, and the male filling element is provided with a liquid product passage which extends through its tubular portion to one or more ports for dispensing the liquid product into the container,
and in that the male filling element has a head which is adapted to couple with the stopper, so that upon introduction of the male filling element into the bore, the head couples with the stopper when in its seat and upon further introduction of the male filling element into the bore, presses the stopper off its seat so that the one or more dispensing ports come in communication with the interior of the container,
and so that upon withdrawal of the male filling element from the bore, the male filling element draws the stopper in its seat, and upon further withdrawal uncouples from the stopper.

The present invention avoids spillage of liquid product on refilling of the container, as the container is closed again after filling even before the male filling element has left the bore of the screw cap. In the prior art systems it is highly likely that a consumer will inadvertently spill from a container before the screw cap was replaced, or even worse the consumer may forget to reapply the screw cap.

It will be appreciated that the refilling station preferably comprises a sensor assembly to detect the presence of a proper screw cap (e.g. mechanically and/or electronically) to make sure that the refilling routine will be executed without problems.

As indicated in the prior art the container may have some identification means, e.g. barcode, RFID transponder, or mechanical features, and the refilling station may have a recognition means for said identification means.

In a preferred embodiment, in particular for a laundry liquid product container, the screw cap is embodied as a dosing cap, e.g. the skirt being such that in inverted position the cap will hold a liquid product volume.

The volume of the dosing cap preferably is at least 10 ml, e.g. 17 ml for a highly concentrated detergent or laundry product. This allows the consumer to pour a volume of liquid product into the unscrewed cap. The cap may be provided with indicia representing different filling volumes, e.g. at regular intervals, e.g. ribs.

In a possible embodiment the screw cap has exterior annular wall extending at a radial distance around said skirt, the exterior annular wall being provided on its inside with screw thread, the exterior annular wall being connected to the skirt via a circumferential flange of the screw cap.

In a possible embodiment the screw has an annular sealing rib depending downward from the circumferential flange, the sealing rib sealingly engaging the neck of the container or the optional fitment.

In a possible embodiment the container is provided with the mentioned optional fitment. Most preferably the fitment is a pour spout fitment, possibly with drain-back facility as is known in the art.

Examples of containers to which the invention can be readily applied are for example shown in WO2009/025717, U.S. Pat. No. 6,923,341, U.S. Pat. No. 6,968,980, U.S. Pat. No. 5,071,037, US2003/0051767. It will be understood that these documents are merely examples and are not to be seen as limiting the scope of the appended claims.

The present invention also relates to a screw cap for use in a system according to the invention.

The present invention also relates to a refilling station for use in a system according to the invention.

The present invention also relates to a liquid product container with screw cap for use with a refilling station having a male filling element introducible into the bore of the screw cap.

The present invention also relates to such a liquid product container with screw cap filled with a liquid product, e.g. a liquid laundry product, e.g. such as a laundry cleaning agent or a laundry softener.

The present invention also relates to a retail shop, e.g. a supermarket or a gas station, equipped with a refilling station and having a storage, e.g. on shelves for sale to consumers, of liquid product containers, preferably filled containers.

The present invention also relates to a method of vending one or more liquid products, in particular to consumers, wherein use is made of the inventive system and wherein containers are refilled with liquid product.

The present invention also relates to a method of refilling a liquid product container of the inventive system.

The invention will now be described in more detail with reference to the drawings. In the drawings:

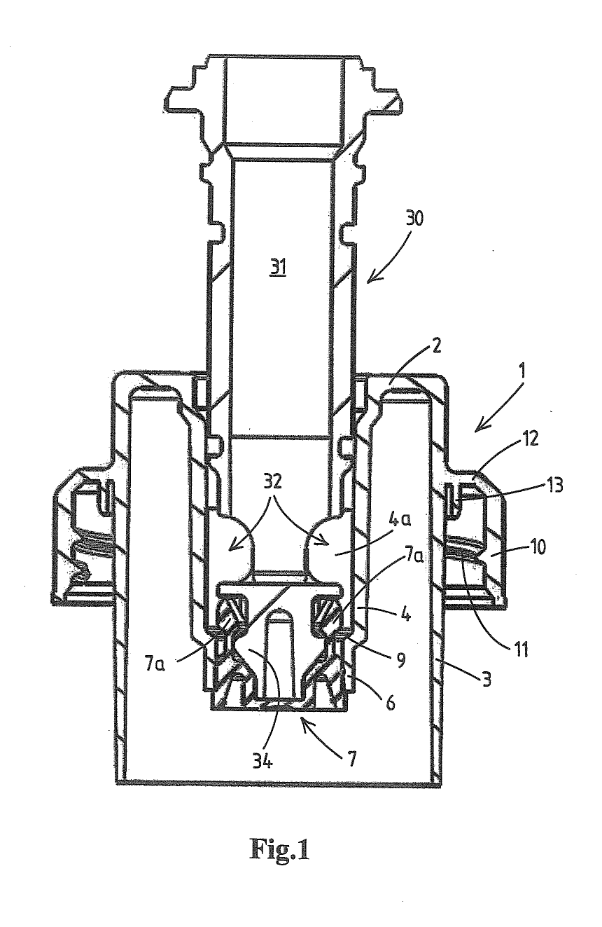

FIG. 1 shows—in vertical cross section—an example of a liquid product dosing screw cap, e.g. of a laundry liquid product container, according to the invention, as well as an associated male filling element,

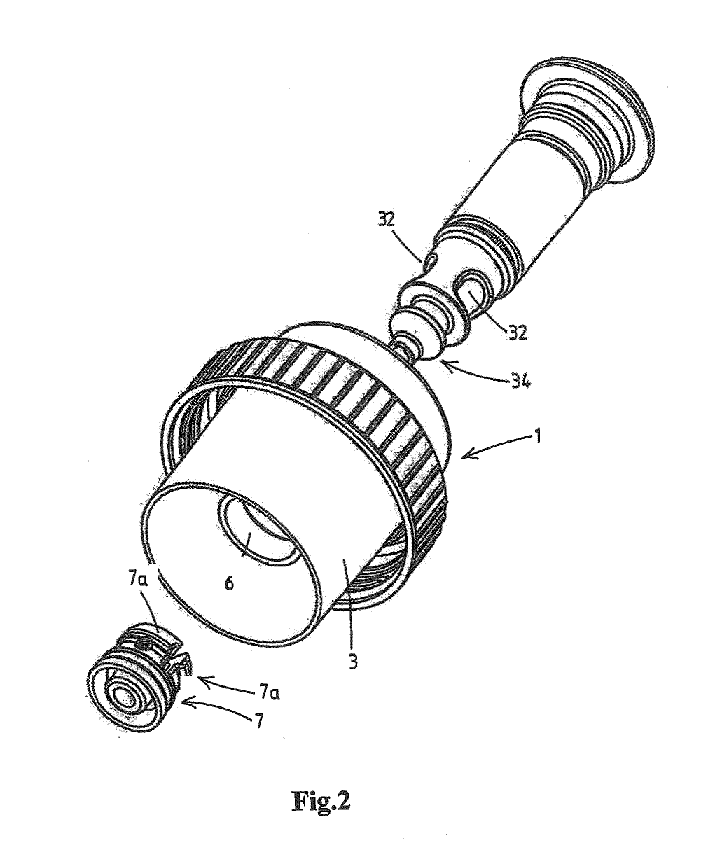

FIG. 2 shows the components of FIG. 1 in exploded view,

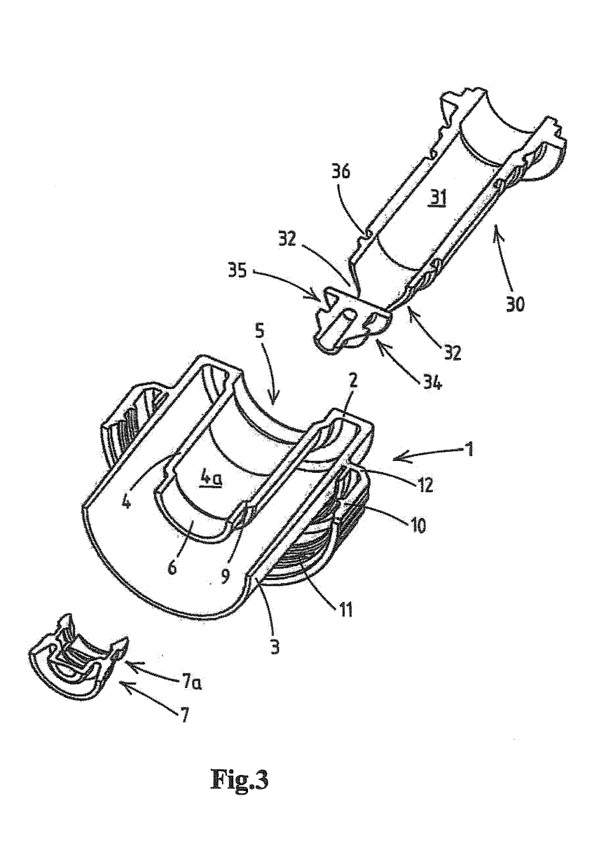

FIG. 3 shows the components of FIG. 1 in exploded view in cross-section,

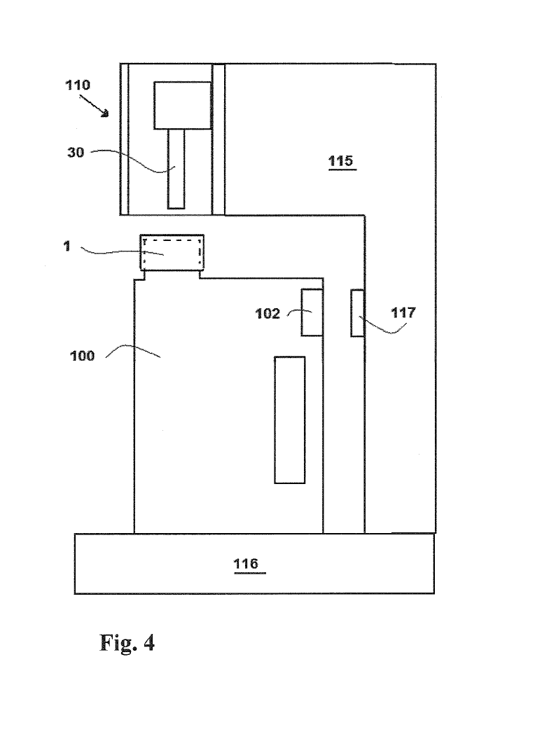

FIG. 4 shows schematically a system according to the invention.

In the drawings only the liquid dosing screw cap is shown, not the associated hand-held or portable liquid product container as such containers are well known in the art, including an preferred optional features thereof, e.g. from documents mentioned above. No further explanation thereof is needed for understanding the present invention.

Also only the male filling element of a refilling station is shown in FIGS. 1-3, not the refilling station itself as such stations are well known in the art, including an preferred optional features thereof, e.g. from documents mentioned above. No further explanation thereof is needed for understanding the present invention. FIG. 4 schematically shows an example of a refilling station and container of a system according to the invention.

As indicated the hand-held liquid product container comprises a body and a neck extending outwardly from the body, preferably at a top region of the container. The neck may be a simple cylindrical neck or formed as a pour spout. Optionally, as often seen for liquid laundry product containers, a dispensing fitment is arranged in said neck to facilitate dispensing of the liquid product from the container.

In a preferred embodiment the container is a unitary blow-molded hand-held plastic liquid container.

The drawings show a manually operable screw cap 1 that is to be removed by a user from the container when the liquid product is to be dispensed from the container. The cap 1 is to be replaced to close the container.

As is preferred the screw cap 1 is a unitary molded plastic product.

The screw cap 1 has a top wall 2 and a downward depending circumferential skirt 3.

The cap 1 is provided with a tubular portion 4, here downwardly extending from the top wall 2, here coaxially with the skirt 3. The tubular portion is embodied as a tubular wall that is integral at its top end with the top wall 2.

The tubular portion forms a bore 4a for male filling element 30 of the refilling station (not shown). The male filling element 30 has a tubular portion a which fits into the bore 4a. Also the male filling element 30 is provided with a liquid product passage 31 which extends through its tubular portion to one or more ports 32 for dispensing the liquid product into the container. As explained the refilling station allows a user to refill the container with a liquid product.

The bore has an insertion opening 5 at the top wall 1 for the male filling element 30.

The tubular portion 4 forms in said bore 4a a seat 6 for a stopper 7, which seat 6 is located at a distance from the insertion opening 5.

As is preferred the stopper 7 is a unitary molded plastic product. The stopper 7 may be integral with the body of the screw cap 1 via one or more flexible arms, or the screw cap 1 may have one or more retaining members cooperating with the screw cap, e.g. providing a support for the stopper in its position when the male filling element is maximally introduced into the bore.

In FIG. 1 the stopper is arranged in the seat 6 to close off the bore 4a.

The male filling element 30 has a head 34 which is adapted to releasable couple with the stopper 7. In FIG. 1 the head 34 is coupled to the stopper 7.

Upon introduction of the male filling element 30 into the bore 4a, the head 34 couples, like a snap fit, with the stopper 7 when in its seat (see FIG. 1). Upon further introduction of the male filling element 30 into the bore 4a, the male filling element 30 presses the stopper 7 off its seat 6, so that the one or more dispensing ports 32 come in communication with the interior of the container. Now the container can be refilled with the liquid product.

Upon withdrawal of the male filling element 30 from the bore 4a, the male filling element draws the stopper 7 in its seat 6, and upon further withdrawal uncouples from the stopper 7.

As will be appreciate the screw cap remains on the container during the refilling process. This avoids many problems associated with prior art refillable container systems, e.g. with regard to accidental spillage. Spillage also has the drawback that the refilling station may be soiled. Retail store operators may not accept the prior art refilling stations as they strive to operate with minimum staff members, and thus have no desire to clean such a station too often.

The screw cap 1 in this example is embodied as a dosing cap. The skirt 3 is such that in inverted position the cap 1 will hold a liquid product volume of at least 10 ml.

In this example the screw cap 1 has exterior annular wall 10 extending at a radial distance around the skirt 3. On the inside thereof the exterior annular wall 10 is provided with screw thread 11, e.g. to mate with screw thread on the container neck or on the optionally provided fitment, e.g. pour spout fitment as is known in the art. It will be appreciated that the screw thread of the cap 1 may also be provided at another location, e.g. on the skirt or on the exterior of the wall 10.

Here the exterior annular wall 10 is connected to the skirt via a circumferential flange 12 of the cap 1.

In this example the cap 1 has an annular sealing rib 13 depending downward from the circumferential flange 12, the sealing rib sealingly engaging the neck of the container or the optional fitment.

As is preferred the stopper 7 is provided at the side facing the head of the male filling element 30 with one or more elastic hook members 7a, e.g. an elastic annular wall or elastic fingers.

One or more of the elastic hook members 7a have an inward directed hook surface that engages a shoulder of the head of the male element, so as to elastically couple (e.g. as snap fit) the male filling element and the stopper.

One or more of the elastic hook members 7a have an outward directed hook surface that can engage on a shoulder 9 of the bore, here adjacent the seat 6, at the side facing the insertion opening 5 of the seat 6.

In the head of the male filling element 30 a recessed circumferential groove 35 is provided. When the stopper 6 is coupled to the head 34, the free ends of the one or more hook members 7a are received in this groove 35 with some play between the male element and the one or more hook 7a members. This allows these free ends to be moved into the groove 35 even further when the hook members 7a are passing through the seat 6 for the stopper 7.

The hook members 7a and head 34 are preferably also such that as long as the head 34 is not correctly coupled to the stopper 7, the free ends of one or more hook members 7a are forced into and/or held in an outward position, in which they can not pass through the opening of the seat 6 and contact the shoulder 9. Thus it is in this preferred embodiment ensured that the head 34 is correctly coupled to the stopper 6 before the stopper 6 is effectively removed from its seat (and here detached from the screw cap as no other connection or retaining member of the screw cap is present).

The male filling element 30 may have one or more O-ring, e.g. in groove 36, to ensure a fluid seal with the inner side of the bore 4.

The container may in an alternative embodiment also be embodied with a body as a collapsible pouch, e.g. a standing pouch, the pouch being provided with a spout forming the neck of the container.

FIG. 4 schematically shows an example of a refilling station and container of a system according to the invention.

A container 100, e.g. a blow-moulded plastic liquid container, is shown, provided with screw cap 1 screwed onto the neck of the container, thereby sealing the container as the stopper is in its seat.

The user has placed the container in a refilling station 110, here embodied with a housing 115 having a platform 116 for placing the container 100 thereon.

Above the receiving position for the container 100 the station 110 is provided with the male filling element 30, here movable up and down upon command by a drive (e.g. an electric motor spindle drive), thereby allowing for the motion of the element 30 into and out off the bore of the cap 1 as explained herein.

The container 100 here has identification means 102, and the station has corresponding recognition means 117.

1. A refillable liquid product container system comprising:
a liquid product container comprising:
a body and a neck extending outwardly from the body, wherein said neck or an optional dispensing fitment arranged in said neck facilitates dispensing of a liquid product from the container; and
a manually operable screw cap that is to be removed by a user from the container when a liquid product is to be dispensed from the container, and that is to be replaced to close the container;
wherein the screw cap has a top wall and a downward depending circumferential skirt, and wherein the screw cap has a screw thread that mates with a screw thread on said neck or on said optional dispensing fitment when present;
a refilling station allowing a user to refill the container with a liquid product, said refilling station comprising a male filling element through which said liquid product is supplied to the container;
wherein the screw cap is provided with a tubular portion, said tubular portion forming a bore for the male filling element of the refilling station, said bore having an insertion opening at the top wall for the male filling element;
wherein said tubular portion forms in said bore a seat for a stopper at a distance from the insertion opening;
wherein the container further comprises a stopper that is arranged in the seat to close off the bore;
wherein the male filling element has a tubular portion which fits into the bore, and the male filling element is provided with a liquid product passage which extends through its tubular portion to one or more ports for dispensing the liquid product into the container;
wherein the male filling element has a head which is adapted to couple with the stopper, so that upon introduction of the male filling element into the bore, the head couples with the stopper when in its seat and upon further introduction of the male filling element into the bore, presses the stopper off its seat so that the one or more dispensing ports come in communication with the interior of the container;
and so that upon withdrawal of the male filling element from the bore, the male filling element draws the stopper in its seat, and upon further withdrawal uncouples from the stopper.

2. System according to claim 1, wherein the tubular portion of the screw cap extends downwardly from the top wall of said cap.

3. System according to claim 1, wherein the container is a unitary blow-molded hand-held plastic container.

4. System according to claim 1, wherein the body of the container is a collapsible pouch, the pouch being provided with a spout forming the neck of the container.

5. System according to claim 1, wherein the screw cap is a dosing cap with an effective dosing volume.

6. Method of refilling a container in a system according to claim 1 comprising:
providing the container with the cap secured onto the neck of the container to be refilled;
bringing the container to the refilling station;
introducing the male filling element into the bore of the cap so as to couple the head of the male filling element to the stopper;
pressing the stopper of its seat;
filling the liquid into the container via the male filling element;
terminating the filling;
withdrawing the male filling element from the bore, thereby pulling the stopper into its seat; and
disconnecting the head from the stopper upon continued withdrawal of the male filling element.

7. System according to claim 5, wherein the effective dosing volume is at least 10 milliliters.
